(19) United States
(12) Patent Application Publication
(10) Pub. No.: US 2024/0076754 A1
(43) Pub. Date: Mar. 7, 2024

(54) MOLTEN IRON REFINING METHOD

(71) Applicant: JFE STEEL CORPORATION, Tokyo (JP)

(72) Inventors: Futoshi OGASAWARA, Tokyo (JP); Hidemitsu NEGISHI, Tokyo (JP); Kenji NAKASE, Tokyo (JP); Shota AMANO, Tokyo (JP); Yumi MURAKAMI, Tokyo (JP); Rei YOKOMORI, Tokyo (JP); Yudai HATTORI, Tokyo (JP); Ryo KAWABATA, Tokyo (JP); Naoki KIKUCHI, Tokyo (JP)

(73) Assignee: JFE STEEL CORPORATION, Tokyo (JP)

(21) Appl. No.: 18/270,617

(22) PCT Filed: Dec. 21, 2021
(86) PCT No.: PCT/JP2021/047268

§ 371 Date: Jun. 30, 2023

(30) Foreign Application Priority Data
Jan. 26, 2021 (JP) 2021-010195

(51) Int. Cl. C21C 5/35; C21C 7/064; C21C 7/068

(52) U.S. Cl. CPC C21C 5/35; C21C 7/064; C21C 7/068

(57) ABSTRACT

A molten iron refining method having, an auxiliary material, and an oxidizing gas supplied through a top-blowing lance, to a cold iron source and molten pig iron that are contained/fed in a converter-type vessel, and molten iron is subjected to a refining process. A pre-charged cold iron source is charged into the converter-type vessel at an amount not larger than 0.15 times. A furnace-top-added cold iron source that's part or all of the cold iron source and added from a furnace top is fed during the refining process. A burner at a leading end of the top-blowing lance that spray holes through which a fuel and a combustion-supporting gas are ejected. During the refining process, a powdery auxiliary material processed into powder that's part of the auxiliary material is blown in, to pass through a flame formed by the burner.

### TECHNICAL FIELD

The present invention relates to a method in which an auxiliary material is added, and an oxidizing gas is supplied through a top-blowing lance, to a cold iron source and molten pig iron that are contained or fed in a converter-type vessel, and molten iron is subjected to a refining process, and relates particularly to a method of performing the process using a large amount of cold iron source.

### BACKGROUND ART

A steelmaking method that performs a dephosphorization process at the stage of molten pig iron (hereinafter referred to as a preliminary dephosphorization process) to reduce the concentration of phosphorus in the molten pig iron to some extent and then performs decarburization blowing in a converter has developed so far. In this preliminary dephosphorization process, an oxygen source, such as gaseous oxygen, is added into the molten pig iron along with a lime-based flux, so that the oxygen source reacts with carbon and silicon in addition to reacting with the phosphorus in the molten pig iron and thereby raises the temperature of the molten pig iron. Since lower temperatures are thermodynamically advantageous for the dephosphorization reaction, the post-process temperature of the molten pig iron is controlled to around 1300° C. to 1400° C. through addition of a cooling material. When the processing vessel is a ladle or a torpedo, stirring is weak and a lance is immersed in the molten pig iron, which poses restrictions on the shape and amount of scrap to be used. A converter-type furnace, on the other hand, has a high bottom-blowing stirring force and does not have a lance immersed, and therefore is advantageous in melting scrap.

In recent years, from the viewpoint of preventing global warming, the steel industry has also been promoting efforts to reduce CO₂ gas emission by cutting down on fossil fuel consumption. At integrated iron mills, molten pig iron is manufactured by reducing iron ore with carbon. Manufacturing this molten pig iron requires about 500 kg of carbon source per ton of molten pig iron for reducing iron ore and other processes. On the other hand, manufacturing molten steel using a cold iron source, such as iron scrap, as a raw material in converter refining does not require a carbon source that is needed to reduce iron ore. In this case, with the energy required to melt the cold iron source taken into account, replacing one ton of molten pig iron with one ton of cold iron source leads to a reduction of about 1.5 tons of CO₂ gas emission. Thus, in a converter steelmaking method using molten iron, increasing the mixing ratio of the cold iron source leads to a reduction of the CO₂ emission. Here, molten iron refers to molten pig iron and a melted cold iron source.

Increasing the amount of cold iron source used requires supplying an amount of heat needed to melt the cold iron source. As mentioned above, heat for melting the cold iron source is usually compensated for by the reaction heat of carbon and silicon contained in the molten pig iron as impurity elements. However, when the mixing ratio of cold iron source is increased, the amount of heat derived from carbon and silicon contained in the molten pig iron alone does not suffice.

For example, Patent Literature 1 proposes a technology of compensating for heat to melt a cold iron source by supplying a heating agent such as ferrosilicon, graphite, or coke into a furnace and supplying an oxygen gas along with the heating agent.

The post-process temperature of the aforementioned preliminary dephosphorization process is about 1300 to 1400° C., which is a temperature lower than the melting point of iron scrap used as the cold iron source. In preliminary dephosphorization blowing, therefore, carbon contained in the molten pig iron is diffused into a surface part of the iron scrap, so that the melting point of the carburized part decreases and melting of the iron scrap progresses. Thus, promoting the mass transfer of carbon contained in the molten pig iron is important in promoting melting of the iron scrap.

For example, Patent Literature 2 proposes a technology that promotes stirring of molten pig iron inside a converter through a supply of a bottom-blown gas and thereby promotes melting of a cold iron source.

Further, Patent Literature 3 proposes a method in which, to perform a dephosphorization process on molten pig iron using a converter-type furnace having a top- and bottom-blowing function, all or part of scrap is added from the furnace top to the molten pig iron during a blowing step, and the timing of adding the scrap to be added during the blowing step is specified to be within the first half of the period of the blowing step.

### CITATION LIST

### Patent Literature

Patent Literature 1: JP-2011-38142A
Patent Literature 2: JP-S 63-169318A
Patent Literature 3: JP-2005-133117A

### SUMMARY OF INVENTION

### Technical Problem

However, these conventional technologies have the following problems.

One problem with the method described in Patent Literature 1 is that, as thermal compensation is made by supplying an oxygen gas required for oxidation and combustion of carbon and silicon of the supplied heating agent, the process time in the converter becomes longer and the productivity becomes lower. Another problem is that combustion of silicon generates SiO₂ and thereby adds to the amount of slag discharged.

As described above, melting of iron scrap as a cold iron source progresses as the carbon concentration in the surface part thereof increases and the melting point decreases due to carburization. In this case, the lower the temperature of the molten pig iron, the higher the concentration of carbon in the carburized part of the iron scrap surface needs be. Thus, carburization requires time, so that melting the iron scrap takes time. In particular, when the temperature of the molten pig iron near the iron scrap has decreased to about the solidification temperature of the molten pig iron, carburization until the carbon concentration in the surface layer of the iron scrap becomes comparable to the carbon concentration in the molten pig iron is required, which causes significant stagnation in melting. Therefore, increasing the stirring force as described in Patent Literature 2 has little promoting effect on melting of the cold iron source.

When a cold iron source and molten pig iron are charged into a converter, the temperature of the molten pig iron decreases due to the sensible heat of the cold iron source, and the temperature of the molten iron inside the furnace remains around the solidification temperature of the molten iron during a period until the cold iron source inside the furnace melts completely in the first half of the dephosphorization process. Therefore, when the mixing ratio of the cold iron source is increased, the temperature of the molten iron inside the furnace remains around the solidification temperature of the molten iron for a longer time.

The method described in Patent Literature 3 can avoid stagnation in melting of the cold iron source due to a decrease in temperature of the molten pig iron during the first half of the dephosphorization process. However, there is a concern that, unless fed during the first half of the blowing step, the cold iron source may not melt completely during the blowing time and remain unmelted. Thus, the amount of cold iron source that can be fed within the practical blowing time is limited, and the mixing ratio of the cold iron source is limited to about 10%. In fact, Patent Literature 2 says that when a desiliconization process was performed using a 300-ton converter-type vessel with the blowing time set to 10 to 12 minutes, the lowest mixing ratio of molten pig iron was 90.9% (i.e., the mixing ratio of a cold iron source was 9.1%). Under conditions where the mixing ratio of the cold iron source is further increased, the amount of cold iron source to be fed from the furnace top during the first half of the dephosphorization process becomes too large and the temperature of the molten pig iron during the first half of the dephosphorization process becomes lower. As a result, the cold iron source remains unmelted.

Having been contrived in view of these circumstances, the present invention aims to propose a molten iron refining method that prevents a cold iron source from remaining unmelted, even under the condition of a high mixing ratio of the cold iron source, while avoiding an increase in the amount of a heat source fed to compensate for heat to melt the cold iron source and in a slag generation amount as well as an increase in the process time.

### Solution to Problem

A first molten iron refining method according to the present invention that advantageously solves the above-described problems is a method in which an auxiliary material is added, and an oxidizing gas is supplied through a top-blowing lance, to a cold iron source and molten pig iron that are contained or fed in a converter-type vessel, and molten iron is subjected to a refining process. Prior to the refining process, a pre-charged cold iron source that is part of the cold iron source and charged all at once into the converter-type vessel before the molten pig iron is charged into the converter-type vessel is charged in an amount not larger than 0.15 times the sum of an amount of the pre-charged cold iron source and a charge amount of the molten pig iron, or is not charged. A furnace-top-added cold iron source that is part or all of the cold iron source and added from a furnace top of the converter-type vessel is fed into the converter-type vessel during the refining process. A burner is further used that is provided at a leading end of the top-blowing lance or at a leading end of a second lance installed separately from the top-blowing lance, and that has spray holes through which a fuel and a combustion-supporting gas are ejected. During at least part of a period of the refining process, a powdery auxiliary material or an auxiliary material processed into powder that is at least part of the auxiliary material is blown in so as to pass through a flame formed by the burner. The first molten iron refining method according to the present invention could be a preferable solution when the longest dimension of the furnace-top-added cold iron source is not larger than 100 mm.

A second molten iron refining method according to the present invention that advantageously solves the above-described problems is the first molten iron refining method in which the refining process is a decarburization process of molten iron. The second molten iron refining method according to the present invention could be a preferable solution when the refining process is a decarburization process that is performed with a converter-type vessel in which molten pig iron dephosphorized beforehand is charged.

A third molten iron refining method according to the present invention that advantageously solves the above-described problems is the first molten iron refining method in which the refining process is a dephosphorization process of molten iron. The third molten iron refining method according to the present invention could be a preferable solution when one or both of the following conditions are met: that the concentration of carbon contained in the furnace-top-added cold iron source is not lower than 0.3 mass %, and that the temperature of the molten iron upon completion of the dephosphorization process is not lower than 1380° C.

A fourth molten iron refining method according to the present invention that advantageously solves the above-described problems is the first molten iron refining method in which: the refining process is a dephosphorization-decarburization process in which a molten iron dephosphorization step, an intermediate slag-off step, and a molten iron decarburization step are performed as a series of processes in the same converter-type vessel; prior to the molten iron dephosphorization step, the pre-charged cold iron source is charged in an amount not larger than 0.15 times the sum of an amount of the pre-charged cold iron source and a charge amount of the molten iron, or is not charged; the furnace-top-added cold iron source is added to the molten iron during one or both of the molten iron dephosphorization step and the molten iron decarburization step; and further, during at least part of a period of one or both of the molten iron dephosphorization step and the molten iron decarburization step, the powdery auxiliary material or the auxiliary material processed into powder is blown in so as to pass through a flame formed by the burner. The fourth molten iron refining method according to the present invention could be a more preferable solution when one or both of the following conditions are met: that the concentration of carbon contained in the furnace-top-added cold iron source that is added during the molten iron dephosphorization step is not lower than 0.3 mass %, and that the temperature of the molten iron upon completion of the molten iron dephosphorization step is not lower than 1380° C.

### Advantageous Effects of Invention

According to the present invention, an upper limit is set for the amount of cold iron source to be charged before the start of a molten iron refining process in a converter-type vessel that is part of a total amount of cold iron source (an amount of all cold iron source) to be used for the refining process, and the cold iron source is added from the furnace top at a stage where the temperature of the molten iron has risen sufficiently. Thus, the time for which the temperature of the molten iron remains low at an initial stage of the refining process can be shortened, and even under the condition where the ratio of the amount of all cold iron source to the charge amount of molten pig iron is increased, stagnation in melting of the cold iron source can be prevented. Even in the case where the cold iron source is fed from the furnace top at a stage where the temperature of the molten iron has risen sufficiently, i.e., during the latter half of the refining process, and the period up to the end of the process is short, a cold iron source, such as reduced iron, containing carbon at a ratio of 0.3 mass % or higher has a low melting point and melts quickly compared with scrap and thus can be prevented form remaining unmelted. Or controlling the post-dephosphorization temperature to 1380° C. or higher can prevent the cold iron source from remaining unmelted.

Further, a burner having spray holes for ejecting a fuel and a combustion-supporting gas is provided at a leading end of a lance that top-blows an oxidizing gas or at a leading end of a lance installed separately from this top-blowing lance, and a powdery auxiliary material or an auxiliary material processed into powder is blown in so as to pass through a flame formed by the burner. Thus, the powdery auxiliary material or the auxiliary material processed into powder is heated by the burner flame, and serves as a heat-transfer medium that can transfer heat to the molten iron inside the converter-type vessel. As a result, heat conduction efficiency increases and less of a carbon source and a silicon source needs to be fed as a heating agent, so that a significant increase in the process time and an addition to the slag generation amount can be avoided.

### BRIEF DESCRIPTION OF DRAWINGS

FIG. 1 is a schematic vertical sectional view showing an overview of a converter-type vessel used in an embodiment of the present invention.

FIG. 2 is a schematic view of a burner used in the embodiment of the present invention, with (a) showing a vertical sectional view of a leading end of a lance and (b) showing a bottom view of ejection holes as seen from below.

FIG. 3 is a schematic view showing a flow of a molten iron refining method according to one embodiment of the present invention.

### DESCRIPTION OF EMBODIMENTS

An embodiment of the present invention will be specifically described below. The drawings are schematic and may differ from the reality. The following embodiment illustrates a device and a method for implementing the technical idea of the present invention, and is not intended to limit the configuration to the one described below. That is, various changes can be made to the technical idea of the present invention within the technical scope described in the claims.

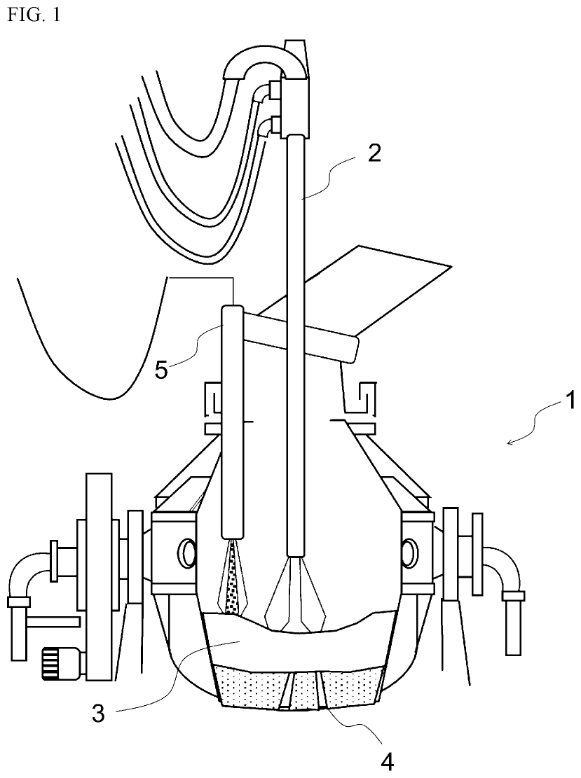

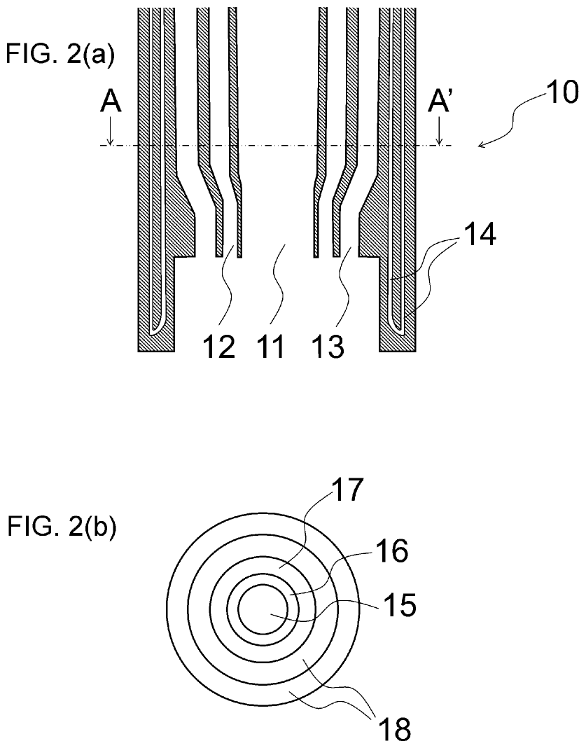

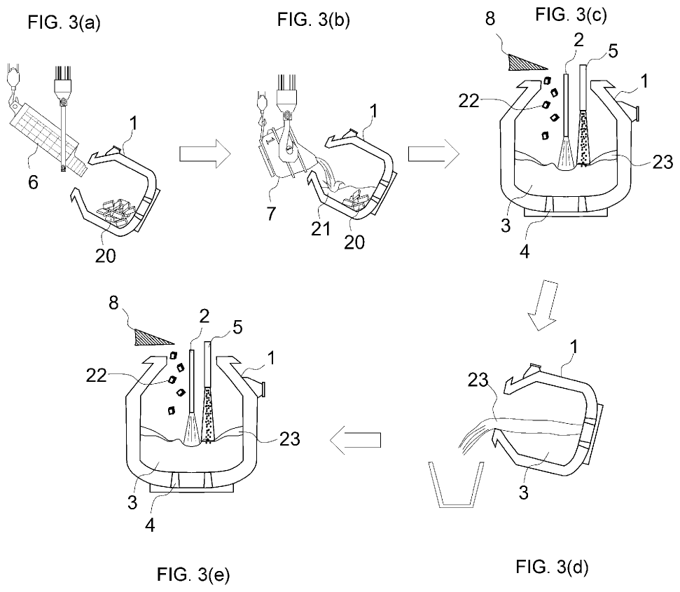

FIG. 1 is a schematic vertical sectional view of a converter-type vessel 1 having a top- and bottom-blowing function that is used for a molten iron refining method of one embodiment of the present invention. FIG. 2 is a schematic view of a leading end of a lance showing the structure of a burner having a powder supply function, with FIG. 2 (a) being a vertical sectional view and FIG. 2 (b) being a view of section A-A. FIG. 3 is a schematic view showing one example of the molten iron refining method of the embodiment.

For example, in FIG. 3 (a), first, iron scrap as a cold iron source 20 to be pre-deposited inside a furnace is charged into the converter-type vessel 1 through a scrap chute 6. Then, in FIG. 3 (b), molten pig iron 21 is charged into the converter-type vessel 1 using a charging ladle 7. The amount of cold iron source charged through the scrap chute 6 is set to an amount not larger than 0.15 times the sum of the amount of the cold iron source and a charge amount of the molten pig iron, or the cold iron source is not pre-charged. A cold iron source 22 to be fed from the furnace top is prepared in a furnace-top hopper 8. As the cold iron source 22 to be fed from the furnace top, iron scrap with small diameters (loose scrap), cut iron scrap (chopped scrap, shredded scrap), small lumps of reduced iron, etc. can be used. It is preferable that iron scrap, lumps of reduced iron, etc. of a large size be processed to a size with a longest dimension not larger than 100 mm (a size that fits in a box with internal dimensions of 100 mm×100 mm×100 mm) by cutting, crushing, etc. such that they can be handled by a furnace-top hopper and conveyance equipment, such as a conveyor.

In FIG. 3 (c), after the molten pig iron is charged, an oxygen gas is top-blown toward molten iron 3 through one lance 2 configured to top-blow an oxidizing gas. An inert gas, such as an argon gas or N₂, is supplied as a stirring gas through a tuyere 4 installed at the bottom of the furnace to stir the molten iron 3. Auxiliary materials, such as a heating agent and a slag forming agent, are added, and the molten iron 3 inside the converter-type vessel 1 is subjected to a dephosphorization process. In this case, a powdery auxiliary material or an auxiliary material processed into powder (hereinafter, both will also be collectively referred to as a powdery auxiliary material), such as lime powder, is supplied using a carrier gas, through a powder supply pipe provided in the one lance 2 that top-blows an oxidizing gas or through a powder supply pipe provided in another lance 5 installed separately from the one lance. Here, at a leading end of the one lance 2 or at a leading end of the other lance 5 installed separately from the one lance 2, a burner having spray holes for ejecting a fuel and a combustion-supporting gas is further provided. During at least part of the period of the dephosphorization process, the powdery auxiliary material supplied through the powder supply pipe is blown in so as to pass through a flame formed by this burner. FIG. 2 shows a schematic view of a leading end of the lance 5 in the case where the lance 5 is provided separately from the one lance 2 and the burner is provided at the leading end of the lance 5. A powder supply pipe 11 is disposed at the center, and a fuel supply pipe 12 and a combustion-supporting gas supply pipe 13 having spray holes are disposed in this order around the powder supply pipe 11. On the outer side of these pipes is an outer shell having cooling water passages 14. A fuel gas 16 and a combustion-supporting gas 17 are supplied through the spray holes provided at an outer circumferential part of the powder supply pipe 11 to form a burner flame. The powdery auxiliary material (powder 15) is heated in this burner flame. Thus, the powdery auxiliary material serves as a heat-transfer medium, which can increase the efficiency of heat conduction to the molten pig iron. As a result, the amount used of the heating agent, such as a carbon source and a silicon source, can be reduced, and an increase in the dephosphorization process time can be prevented. To efficiently transfer heat to the powder, it is important to secure a time for which the powder 15 is retained inside the burner flame. As the oxidizing gas, other than pure oxygen, a mixed gas of oxygen and CO₂ or an inert gas can be used. As the combustion-supporting gas, air, oxygen-enriched air, and an oxidizing gas can be used. As the fuel to be supplied, a fuel gas such as a liquefied natural gas (LNG) or a liquefied petroleum gas (LPG), a liquid fuel such as heavy oil, and a solid fuel such as coke powder can be used, but a fuel containing a small amount of carbon source is preferable from the viewpoint of reducing the CO₂ emission.

Using the converter-type vessel 1, the present inventors conducted a test of heating lime powder by the burner with the flow rate of the carrier gas and the height of the lance changed to various values. As a result, we found that high heat conduction efficiency was achieved when the time of retention inside the burner flame was set to about 0.05 seconds to 0.1 seconds. To secure the time of retention inside the flame, it is effective to increase the time taken for the powder to reach the surface of the molten iron after being sprayed. Specifically, it is effective to lower the flow velocity of the powder. However, transporting the powder through the inside of a pipe requires supplying a carrier gas at a constant flow rate. Under practical operation conditions, the flow velocity of the powder is within a range of 40 m/s to 60 m/s. Therefore, to secure the time of retention inside the flame, the powder discharge hole is preferably located at a level of about 2 to 4 m above the molten iron surface. It is preferable that the feed amount of a heating material, such as a carbon source and a silicon source, be reduced in anticipation of an increase in the amount of heat conducted resulting from the powdery auxiliary material being added while being heated by the burner.

In FIG. 3 (c), the cold iron source 22 is fed from the furnace top at a timing when the scrap 20 having been charged through the scrap chute 6 melts and the temperature of the molten iron starts to rise as the dephosphorization process progresses. If the cold iron source 22 is fed from the furnace top after the timing when the temperature of the molten iron starts to rise, i.e., fed during the latter half of the dephosphorization process, the period from the start of feeding of the cold iron source 22 to the end of the process becomes shorter, and the cold iron source may remain unmelted. However, when a cold iron source, such as reduced iron, containing carbon at a ratio of 0.3 mass % or higher is used as the furnace-top-fed cold iron source, the cold iron source, even when fed during the latter half of the dephosphorization process, can be prevented from remaining unmelted. Also when scrap containing a smaller amount of carbon is fed from the furnace top, using the burner lance or the like and controlling the post-dephosphorization temperature to 1380° C. or higher can prevent the cold iron source from remaining unmelted. After completion of the dephosphorization process, discharge of the molten metal or intermediate slag-off (FIG. 3 (d)) is performed, and a decarburization process (FIG. 3 (e)) is performed. In this decarburization process, adding the cold iron source 22 from the furnace top and heating it by the burner can be performed in combination as in the latter half of the dephosphorization process.

The above-described example has shown the molten iron refining method that charges and feeds a cold iron source during a dephosphorization process and subsequently performs a decarburization process. However, the present invention is also applicable to a molten iron refining process that performs only a decarburization process independently, and to a molten iron refining method that performs a decarburization process on molten pig iron having been dephosphorized beforehand. The present invention can of course be applied to a molten iron refining method that performs only a dephosphorization process independently. In addition, it can also be applied to only one of a dephosphorization step and a decarburization step that are sequentially performed.

In the case where the refining process in the present invention is a dephosphorization-decarburization process in which a molten iron dephosphorization step, an intermediate slag-off step, and a molten iron decarburization step are performed as a series of processes in the same converter-type vessel, the timing of adding the furnace-top-added cold iron source from the furnace top of the converter-type vessel is during the period of so-called blowing in which an oxidizing gas is supplied into the furnace in the dephosphorization step or the decarburization step, and a period after completion of the dephosphorization step until supply of the oxidizing gas is temporarily stopped and the decarburization step is started, and a period during intermediate slag-off are excluded.

The molten pig iron is not limited to molten pig iron discharged from a blast furnace. The present invention is applicable as well also when the molten pig iron is molten pig iron obtained by a cupola, an induction melting furnace, an arc furnace, etc., or is molten pig iron obtained by mixing such molten pig iron with molten pig iron discharged from a blast furnace.

### EXAMPLES

### Example 1

Using molten pig iron discharged from a blast furnace and a cold iron source (scrap), a dephosphorization process was performed in a 330-ton-capacity top- and bottom-blowing converter (with an oxygen gas top-blown and an argon gas bottom-blown). The amount of molten pig iron, the amount of cold iron source fed through the scrap chute, and the amount of cold iron source fed from the furnace top were changed to various amounts. Iron scrap was used as the cold iron source fed through the scrap chute, and cut scrap was used as the cold iron source added from the furnace top, with the cold iron source having a carbon concentration of 0.1 mass %. The result is shown in Table 1.

TABLE 1

| | | Amount | Ratio | Amount of | | | | Dephos- | | | |
|---|---|---|---|---|---|---|---|---|---|---|---|
| | Charge | of pre- | of pre- | furnace- | | | Heating | phori- | Slag | Ratio of | |
| | amount of | charged | charged | top-added | Cold iron | | agent feed | zation | discharge | all cold | |
| | molten | cold iron | cold iron | cold iron | source | Burner | amount | process | amount | iron | |
| | pig iron | source | source | source | Unmelted/ | Used/ | index | time index | index | source | |
| No. | t | t | % | t | Melted | Not used | — | — | — | % | Remarks |
| 1 | 297 | 33 | 10.0 | 0 | Melted | Not used | 1.0 | 1.0 | 1.0 | 10.0 | Comparative Example |
| 2 | 284 | 46 | 13.9 | 0 | Melted | Not used | 1.1 | 1.1 | 1.1 | 13.9 | Comparative Example |
| 3 | 277 | 53 | 16.1 | 0 | Unmelted | Not used | 1.3 | 1.3 | 1.3 | 16.1 | Comparative Example |
| 4 | 264 | 66 | 20.0 | 0 | Unmelted | Not used | 1.4 | 1.4 | 1.4 | 20.0 | Comparative Example |
| 5 | 277 | 53 | 16.1 | 0 | Unmelted | Used | 1.0 | 1.0 | 1.0 | 16.1 | Comparative Example |
| 6 | 277 | 48 | 14.8 | 5 | Melted | Used | 1.0 | 1.0 | 1.0 | 16.1 | Invention Example |
| 7 | 264 | 46 | 14.8 | 20 | Melted | Used | 1.0 | 1.0 | 1.0 | 20.0 | Invention Example |
| 8 | 264 | 46 | 14.8 | 20 | Melted | Not used | 1.4 | 1.4 | 1.4 | 20.0 | Comparative Example |

In Processes No. 1 to 5, all the scrap as the cold iron source was charged into the converter through the scrap chute before the molten pig iron was charged, and a dephosphorization process was performed. The post-dephosphorization temperature was adjusted to 1350° C. In only Process No. 5, during the dephosphorization process, a burner having spray holes for ejecting a fuel and a combustion-supporting gas was provided at a leading end of a second lance installed separately from the top-blowing lance, and five tons of lime powder was added into the furnace so as to pass through the flame formed by this burner. The level of the second lance was set to 3.5 m, and the flow rate of a powder conveying gas, which was a nitrogen gas, was set to 25 Nm³/min. A propane gas was used as the fuel gas, with the flow rate set to 15 Nm³/min. An oxygen gas as the combustion-supporting gas was supplied at a rate of 75 Nm³/min.

In Processes No. 6 and 7, the amount of cold iron source to be charged through the scrap chute before the molten pig iron was charged was set to be not larger than 0.15 times the sum of the charge amount of the molten pig iron and the charge amount of the scrap, i.e., the ratio of the cold iron source to be charged through the scrap chute before the molten pig iron was charged (“ratio of pre-charged cold iron source” in Table 1; hereinafter referred to as “ratio of cold iron source”) was set to be not higher than 15% of the sum of the amount of the cold iron source and the charge amount of the molten pig iron, and then cut scrap or reduced iron was fed from the furnace top during the dephosphorization process that was started after the molten pig iron was charged. The post-dephosphorization temperature was adjusted to 1350° C. The concentration of carbon contained in the cold iron source fed from the furnace top was 0.1 mass %. Further, under the same conditions as in Process No. 5, the burner was used during the dephosphorization process.

In Process No. 8, the ratio of the cold iron source to be charged through the scrap chute before the molten pig iron was charged was set to be not higher than 15% of the sum of the amount of the cold iron source and the charge amount of the molten pig iron, and cut scrap was fed from the furnace top during the dephosphorization process that was started after the molten pig iron was charged. The post-dephosphorization temperature was adjusted to 1350° C. The concentration of carbon in the cut scrap was 0.1 mass %. The burner was not used.

Under the conditions where lime powder was added through the burner flame (Processes No. 5 to 7), the lime powder served as a heat-transfer medium and transferred the heat of the burner flame to the molten iron and the slag, so that the amount of heat conducted was larger than that in comparative examples in which the burner was not used (Processes No. 1 to 4 and 8). Thus, the conditions where the burner was used allowed a reduction in the amount used of the heating source, such as a carbon source and a silicon source. As a result, advantages were achieved in that the amount of oxygen required to combust the heating source was reduced and that the dephosphorization process time was shortened. Moreover, results were yielded that the amount of SiO₂ generated by combustion of a silicon source was reduced and that the amount of slag generation was reduced. In the comparative examples in which the burner was not used (Processes No. 1 to 4 and 8), the feed amount of the heat source for compensating for the heat to melt the cold iron source, the dephosphorization process time, and the slag discharge amount increased as the ratio of the cold iron source increased. Here, the heating agent feed amount index, the dephosphorization process time index, and the slag discharge amount index are respectively values obtained by dividing the amount of heat generated by a fed heating material, such as a coal material or ferrosilicon, the refining process time (dephosphorization process time), and the slag discharge amount by the actual values of Process No. 1.

However, under the conditions where the ratio of the pre-charged cold iron source to the total charge amount (molten pig iron+pre-charged cold iron source) exceeded 15% (Processes No. 3, 4, and 5), scrap remained unmelted regardless of whether the burner was used or not.

### Example 2

In Processes No. 9 and 10, in performing the dephosphorization process as in Example 1, the ratio of the cold iron source to be charged through the scrap chute before the molten pig iron was charged was set to be not higher than 15% of the sum of the amount of the cold iron source and the charge amount of the molten pig iron. Further, a cold iron source was fed from the furnace top during the dephosphorization process that was started after the molten pig iron was charged. The concentration of carbon in the cold iron source was changed from 0.1 mass % to 0.31 mass %. The post-dephosphorization temperature of the molten iron was controlled to 1350° C. to 1380° C. In addition, the burner was used during the dephosphorization process under the same conditions as in Process No. 5. The conditions and the result are shown in Table 2 together.

TABLE 2

| | Pre-charge | | | Furnace-top addition | | Post-dephosphorization | | | |
|---|---|---|---|---|---|---|---|---|---|
| | Amount of | Amount of | Ratio of | Amount of | | | Cold iron | Ratio of all | |
| | molten pig | cold iron | cold iron | cold iron | Carbon | Molten iron | source | cold iron | |
| | iron | source | source | source | concentration | temperature | Unmelted/ | source | |
| No. | t | t | % | t | mass % | ° C. | Melted | % | Remarks |
| 9 | 247 | 43 | 14.8 | 40 | 0.31 | 1350 | Melted | 25.2 | Invention Example |
| 10 | 247 | 43 | 14.8 | 40 | 0.10 | 1385 | Melted | 25.2 | Invention Example |

As is clear from Table 2, when the concentration of carbon contained in the cold iron source fed from the furnace top was 0.3 mass % or higher (Process No. 9), or a temperature upon completion of the dephosphorization process of 1380° C. or higher was secured (Process No. 10), the cold iron source was prevented from remaining unmelted even under the condition of an even higher ratio of all cold iron source than in Process No. 6 or 7 of Example 1. Here, the ratio of all cold iron source is the percentage of the mass of the cold iron source to the mass of the entire iron source including charged or fed molten pig iron.

### Example 3

The dephosphorization process was performed under the same conditions as in Example 1. In Processes No. 11 to 13, the ratio of the cold iron source to be charged through the scrap chute before the molten pig iron was charged was set to be not higher than 15% of the sum of the amount of the cold iron source and the charge amount of the molten pig iron, and further, reduced iron was fed from the furnace top during the dephosphorization process that was started after the molten pig iron was charged. The concentration of carbon in the reduced iron was 0.5 mass %. The post-dephosphorization temperature was controlled to 1350° C. In addition, the burner was used during the dephosphorization process under the same conditions as in Process No. 5. As a result of changing the dimensions of the reduced iron to various values, the result shown in Table 3 was obtained. Setting the longest dimension to 100 mm or smaller allowed the reduced iron to be stably fed from the furnace top without causing a trouble in a conveyance system, such as a conveyor.

TABLE 3

| | Pre-charge | | | Furnace-top addition | | Post-dephosphorization | | | | |
|---|---|---|---|---|---|---|---|---|---|---|
| | Amount of | Amount of | Ratio of | Amount of | Dimensions | | Cold iron | Any trouble | Ratio of all | |
| | molten | cold iron | cold iron | cold iron | of cold | Molten iron | source | in conveyance | cold iron | |
| | pig iron | source | source | source | iron source | temperature | Unmelted/ | system | source | |
| No. | t | t | % | t | mm × mm × mm | ° C. | Melted | Yes/No | % | Remarks |
| 11 | 264 | 46 | 14.8 | 20 | 150 × 150 × 150 | 1350 | Melted | Yes | 20.0 | Invention |
| | | | | | | | | | | Example |
| 12 | 264 | 46 | 14.8 | 20 | 110 × 110 × 110 | 1350 | Melted | Yes | 20.0 | Invention |
| | | | | | | | | | | Example |
| 13 | 264 | 46 | 14.8 | 20 | 90 × 90 × 90 | 1350 | Melted | No | 20.0 | Preferable |
| | | | | | | | | | | Example |

### Example 4

Using molten pig iron discharged from a blast furnace and a cold iron source (scrap), a decarburization process was performed in a 330-ton-capacity top- and bottom-blowing converter (with an oxygen gas top-blown and an argon gas bottom-blown). The amount of molten pig iron, the amount of cold iron source fed through the scrap chute, and the amount of cold iron source fed from the furnace top were changed to various values. Scrap was used as the cold iron source fed through the scrap chute, and cut scrap or reduced iron was used as the cold iron source added from the furnace top, with the cold iron source having a carbon concentration of 0.10 mass %. The post-decarburization temperature was 1650° C. In addition, for Process No. 15, the burner was used during the decarburization process under the same conditions as in Process No. 5. The result is shown in Tables 4-1 and 4-2.

TABLE 4-1

| | Pre-charge | | | Furnace-top addition | | Post-dephosphorization | |
|---|---|---|---|---|---|---|---|
| | Amount of | Amount of | Ratio of | Amount of | | | Ratio of |
| | molten | cold iron | cold iron | cold iron | Carbon | Molten iron | all cold |
| | pig iron | source | source | source | concentration | temperature | iron source |
| No. | t | t | % | t | mass % | ° C. | % |
| 14 | 264 | 46 | 14.8 | 20 | 0.10 | 1650 | 20.0 |
| 15 | 264 | 46 | 14.8 | 20 | 0.10 | 1650 | 20.0 |

TABLE 4-2

| | Cold iron | | Heating | Decarburization | Slag | |
|---|---|---|---|---|---|---|
| | source | Burner | agent feed | process time | discharge | |
| | Unmelted/ | Used/ | amount index | index | amount index | |
| No. | Melted | Not used | — | — | — | Remarks |
| 14 | Melted | Not used | 1.4 | 1.4 | 1.4 | Comparative |
| | | | | | | Example |
| 15 | Melted | Used | 1.0 | 1.0 | 1.0 | Invention |
| | | | | | | Example |

When the conditions of the present invention were applied (No. 15), the cold iron source did not remain unmelted, and there was no increase in the heating agent, the decarburization process time, and the slag discharge amount. Here, the heating agent feed amount index, the decarburization process time index, and the slag discharge amount index are respectively values obtained by dividing the amount of heat generated by the fed heating material, such as a coal material or ferrosilicon, the refining process time (decarburization process time), and the slag discharge amount by the actual values of Process No. 15.

### Example 5

Using molten pig iron discharged from a blast furnace and a cold iron source (scrap), a dephosphorization process was performed and, after intermediate slag-off, decarburization blowing was performed in a 330-ton-capacity top- and bottom-blowing converter (with an oxygen gas top-blown and an argon gas bottom-blown). The amount of molten pig iron, the amount of cold iron source fed through the scrap chute, and the amount of cold iron source fed from the furnace top were changed to various values. Scrap was used as the cold iron source fed through the scrap chute, and cut scrap or reduced iron was used as the cold iron source added from the furnace top, with the cold iron source having a carbon concentration of 0.10 to 0.80 mass %. The post-dephosphorization temperature was changed from 1350 to 1385° C. In addition, for Processes No. 21 to 25, the burner was used during the decarburization process under the same conditions as in Process No. 5. The result is shown in Tables 5-1 and 5-2.

TABLE 5-1

| | Dephosphorization step | | | | | | Decarburization step | | |
|---|---|---|---|---|---|---|---|---|---|
| | Pre-charge | | | Furnace-top addition | | | Furnace-top addition | | |
| | Amount of | Amount of | Ratio of | Amount of | | Post-process | Amount of | | Post-process |
| | molten pig | cold iron | cold iron | cold iron | Carbon | Molten iron | cold iron | Carbon | Molten iron |
| | iron | source | source | source | concentration | temperature | source | concentration | temperature |
| No. | t | t | % | t | mass % | ° C. | t | mass % | ° C. |
| 16 | 248 | 43 | 14.8 | 16 | 0.10 | 1350 | 23.1 | 0.10 | 1650 |
| 17 | 248 | 43 | 14.8 | 16 | 0.25 | 1350 | 23.1 | 0.10 | 1650 |
| 18 | 231 | 40 | 14.8 | 36 | 0.32 | 1350 | 23.1 | 0.10 | 1650 |
| 19 | 248 | 43 | 14.8 | 16 | 0.10 | 1375 | 23.1 | 0.10 | 1650 |
| 20 | 231 | 40 | 14.8 | 36 | 0.10 | 1380 | 23.1 | 0.10 | 1650 |
| 21 | 248 | 43 | 14.8 | 16 | 0.10 | 1350 | 23.1 | 0.10 | 1650 |
| 22 | 248 | 43 | 14.8 | 16 | 0.25 | 1350 | 23.1 | 0.10 | 1650 |
| 23 | 231 | 40 | 14.8 | 36 | 0.32 | 1350 | 23.1 | 0.10 | 1650 |
| 24 | 248 | 43 | 14.8 | 16 | 0.10 | 1375 | 23.1 | 0.10 | 1650 |
| 25 | 231 | 40 | 14.8 | 36 | 0.10 | 1380 | 23.1 | 0.10 | 1650 |

TABLE 5-2

| | Cold iron | | Heating agent | Decarburization | | Ratio of | |
|---|---|---|---|---|---|---|---|
| | source | Burner | feed amount | process time | Slag discharge | all cold | |
| | Unmelted/ | Used/ | index | index | amount index | iron source | |
| No. | Melted | Not used | — | — | — | % | Remarks |
| 16 | Melted | Not used | 1.6 | 1.6 | 1.6 | 24.9 | Comparative Example |
| 17 | Melted | Not used | 1.6 | 1.6 | 1.6 | 24.9 | Comparative Example |
| 18 | Melted | Not used | 1.8 | 1.8 | 1.8 | 30.0 | Comparative Example |
| 19 | Melted | Not used | 1.6 | 1.6 | 1.6 | 24.9 | Comparative Example |
| 20 | Melted | Not used | 1.8 | 1.8 | 1.8 | 30.0 | Comparative Example |
| 21 | Melted | Used | 1.0 | 1.0 | 1.0 | 24.9 | Invention Example |
| 22 | Melted | Used | 1.0 | 1.0 | 1.0 | 24.9 | Invention Example |
| 23 | Melted | Used | 1.1 | 1.1 | 1.1 | 30.0 | Invention Example |
| 24 | Melted | Used | 1.0 | 1.0 | 1.0 | 24.9 | Invention Example |
| 25 | Melted | Used | 1.1 | 1.1 | 1.1 | 30.0 | Invention Example |

When the present invention was applied (Processes No. 21 to 25), the cold iron source did not remain unmelted and there was no increase in the heating agent, the refining process time, and the slag discharge amount. Under the conditions where the concentration of carbon contained in the cold iron source fed from the furnace top during dephosphorization blowing was 0.3 mass % or higher, or where the post-dephosphorization temperature was not lower than 1380° C. (Processes No. 23 and 25), an even higher ratio of all cold iron source was achieved. Here, the heating agent feed amount index, the decarburization process time index, and the slag discharge amount index are respectively values obtained by dividing the amount of heat generated by the fed heating material, such as a coal material or ferrosilicon, the refining process time (decarburization process time), and the slag discharge amount by the actual values of Process No. 21.

While examples in which a refining process is performed in a converter-type vessel using molten pig iron discharged from a blast furnace and a cold iron source (scrap etc.) have been shown in the above-described Examples, it has been confirmed that the present invention is applicable as well also when the molten pig iron is molten pig iron obtained by a cupola, an induction melting furnace, an arc furnace, etc., or is molten pig iron obtained by mixing such molten pig iron with molten pig iron discharged from a blast furnace.

### INDUSTRIAL APPLICABILITY

The molten iron refining method according to the present invention can use a significantly larger amount of cold iron source, requires less of a carbon source and a silicon source to be fed as a heating agent, and can avoid a significant increase in the process time and an increase in the slag generation amount, which makes this method useful for industrial purposes.

### REFERENCE SIGNS LIST

1 Converter-type vessel
2 Top-blowing lance for oxidizing gas
3 Molten iron
4 Bottom-blowing tuyere
5 Burner lance
6 Scrap chute
7 Charging ladle
8 Furnace-top hopper
10 Burner lance leading end
11 Powder supply pipe
12 Fuel supply pipe
13 Combustion-supporting gas supply pipe
14 Cooling water passage
15 Powder
16 Fuel
17 Combustion-supporting gas
18 Cooling water
20 Pre-charged scrap
21 Molten pig iron
22 Furnace-top-added cold iron source
23 Slag

1. A molten iron refining method in which an auxiliary material is added, and an oxidizing gas is supplied through a top-blowing lance, to a cold iron source and molten pig iron that are contained or fed in a converter-type vessel, and molten iron is subjected to a refining process,
wherein:
prior to the refining process, a pre-charged cold iron source that is part of the cold iron source and charged all at once into the converter-type vessel before the molten pig iron is charged into the converter-type vessel is charged in an amount not larger than 0.15 times a sum of an amount of the pre-charged cold iron source and a charge amount of the molten pig iron, or is not charged;
a furnace-top-added cold iron source that is part or all of the cold iron source and added from a furnace top of the converter-type vessel is fed into the converter-type vessel during the refining process;
a burner is further used that is provided at a leading end of the top-blowing lance or at a leading end of a second lance installed separately from the top-blowing lance, and that has spray holes through which a fuel and a combustion-supporting gas are ejected; and
during at least part of a period of the refining process, a powdery auxiliary material or an auxiliary material processed into powder that is at least part of the auxiliary material is blown in so as to pass through a flame formed by the burner.

2. The molten iron refining method according to claim 1, wherein a longest dimension of the furnace-top-added cold iron source is not larger than 100 mm.

3. The molten iron refining method according to claim 1, wherein the refining process is a decarburization process of molten iron.

4. The molten iron refining method according to claim 3, wherein the refining process is a decarburization process that is performed with a converter-type vessel in which molten pig iron dephosphorized beforehand is charged.

5. The molten iron refining method according to claim 1, wherein the refining process is a dephosphorization process of molten iron.

6. The molten iron refining method according to claim 5, wherein one or both of the following conditions are met: that the concentration of carbon contained in the furnace-top-added cold iron source is not lower than 0.3 mass %, and that the temperature of the molten iron upon completion of the dephosphorization process is not lower than 1380° C.

7. The molten iron refining method according to claim 1, wherein:
the refining process is a dephosphorization-decarburization process in which a molten iron dephosphorization step, an intermediate slag-off step, and a molten iron decarburization step are performed as a series of processes in the same converter-type vessel;
prior to the molten iron dephosphorization step, the pre-charged cold iron source is charged in an amount not larger than 0.15 times a sum of an amount of the pre-charged cold iron source and a charge amount of the molten iron, or is not charged;
the furnace-top-added cold iron source is added to the molten iron during one or both of the molten iron dephosphorization step and the molten iron decarburization step; and
further, during at least part of a period of one or both of the molten iron dephosphorization step and the molten iron decarburization step, the powdery auxiliary material or the auxiliary material processed into powder is blown in so as to pass through a flame formed by the burner.

8. The molten iron refining method according to claim 7, wherein one or both of the following conditions are met: that the concentration of carbon contained in the furnace-top-added cold iron source that is added during the molten iron dephosphorization step is not lower than 0.3 mass %, and that the temperature of the molten iron upon completion of the molten iron dephosphorization step is not lower than 1380° C.

9. The molten iron refining method according to claim 2, wherein the refining process is a dephosphorization process of molten iron.

10. The molten iron refining method according to claim 9, wherein the refining process is a decarburization process that is performed with a converter-type vessel in which molten pig iron dephosphorized beforehand is charged.

11. The molten iron refining method according to claim 2, wherein the refining process is a dephosphorization process of molten iron.

12. The molten iron refining method according to claim 11, wherein one or both of the following conditions are met: that the concentration of carbon contained in the furnace-top-added cold iron source is not lower than 0.3 mass %, and that the temperature of the molten iron upon completion of the dephosphorization process is not lower than 1380° C.

13. The molten iron refining method according to claim 2, wherein:
the refining process is a dephosphorization-decarburization process in which a molten iron dephosphorization step, an intermediate slag-off step, and a molten iron decarburization step are performed as a series of processes in the same converter-type vessel;
prior to the molten iron dephosphorization step, the pre-charged cold iron source is charged in an amount not larger than 0.15 times a sum of an amount of the pre-charged cold iron source and a charge amount of the molten iron, or is not charged;
the furnace-top-added cold iron source is added to the molten iron during one or both of the molten iron dephosphorization step and the molten iron decarburization step; and
further, during at least part of a period of one or both of the molten iron dephosphorization step and the molten iron decarburization step, the powdery auxiliary material or the auxiliary material processed into powder is blown in so as to pass through a flame formed by the burner.

14. The molten iron refining method according to claim 13, wherein one or both of the following conditions are met: that the concentration of carbon contained in the furnace-top-added cold iron source that is added during the molten iron dephosphorization step is not lower than 0.3 mass %, and that the temperature of the molten iron upon completion of the molten iron dephosphorization step is not lower than 1380° C.
